(19) United States
(12) Patent Application Publication
(10) Pub. No.: US 2026/0077944 A1
(43) Pub. Date: Mar. 19, 2026

(54) DOUBLE-LAYER CONTAINING APPARATUS WITH INTERNAL HEATING MECHANISM AND PROCESS OF MANUFACTURING SAME

(71) Applicant: APPLIED FLUOROPLASTICS CO., LTD., Taichung City (TW)

(72) Inventor: CHIEN-CHIH HO, Taichung City (TW)

(21) Appl. No.: 19/324,116

(22) Filed: Sep. 10, 2025

(30) Foreign Application Priority Data
Sep. 18, 2024 (TW) 113135302

(51) Int. Cl. B65D 88/74; B29C 65/00; B29C 65/34; B29K 27/12; B29L 31/00; H05B 1/02; H05B 3/00

(52) U.S. Cl. CPC B65D 88/744; B29C 65/34; B29C 66/532; B65D 88/748; H05B 1/023; H05B 3/0014; B29K 2027/12; B29L 2031/712; H05B 2203/007

(57) ABSTRACT

A double-layer containing apparatus includes a double-layer container including an inner shell, an outer shell, and spacers. The inner shell forms a storage space. The inner shell is made of fluorine-containing thermoplastic and has a first melting point. The spacers are disposed between the inner shell and the outer shell. Each partition includes first and second surfaces. The first surface has recesses facing the inner shell. The second surface contacts the outer shell. The apparatus further comprises a heating device including a controller, wires, and electric heating elements which are correspond to the spacers respectively. A process of manufacturing the double-layer containing apparatus is also provided.

### FIELD OF THE INVENTION

The invention relates to double-layer containers and more particularly to a double-layer containing apparatus having an internal heating mechanism and a process of manufacturing same having the advantages of being convenient in design and having increased heating efficiency due to shorter heat transfer path.

### BACKGROUND OF THE INVENTION

As shown in FIGS. 9, 10, 11 and 12, Taiwan Patent No. I711536 entitled “Liquid containing apparatus and method of manufacturing same” (substantially equivalent to U.S. Pat. No. 11,932,484 entitled “CONTAINER FOR STORING LIQUIDS AND MANUFACTURING METHOD THEREOF”) discloses a double-layer containing apparatus comprising a container 90 including an inner shell 91, an outer shell 92, and spacers 93 (or called partitions). The of spacers 93 are disposed between the inner shell 91 and the outer shell 92. The inner shell 91 defines a storage space 911. Each of the spacers 93 includes a first surface 931 and a second surface 932. The first surface 931 has recesses 93A facing the inner shell 91. The second surface 932 contacts the outer shell 92.

However, a conventional heating method involves placing a heating device inside (or outside) the storage space 911. This is well known in the art and not shown in the drawings. The heating device may heat the inner shell 91 at a position just adjacent to the recesses 93A to form protrusions 912 (see FIGS. 11 and 12). While the heating method is feasible, it still has the following problems:

If ultrasonic vibration heating is used, the entire heating device is required to move into the storage space 911. However, it may be impossible to achieve if the inlet of the container 90 is too small or the storage space 911 is limited. Further, the ultrasonic vibration heating has a limited application. For example, it is not suitable for housings made of fluorine material.

Furthermore, since the container 90 is generally cylindrical, the pacers 93 surround the container 90 in a 360-degree circle. Thus, it is often required to divide 360-degree into several heating processes (such as every 60 degrees as a segment for one process; so it needs 6 segmented heating processes) complete the heating operation of the entire circle (i.e., 360 degrees). However, it is very time-consuming and troublesome.

In addition, if a conventional electric heating device (not shown) is used for direct heating from inside, it must penetrate the inner shell 91 (i.e., the entire shell) from the storage space 911 in order to transfer heat to the first surface 931. Assuming that the inner shell 91 is thicker, the temperature of the electric heating device contacting the inner shell 91 must be increased (or heating time increase) to ensure that the required heating temperature (for example, slightly greater than the melting point) is reached on the first surface 931. That is, the thicker the inner shell 91, the greater the temperature difference between the storage space 911 and the first surface 931, and more likely that properties of the material of the inner shell 91 will deteriorate due to excessively high temperatures. At the same time, the heat transfer path is relatively long (i.e., lower heat transfer efficiency).

Thus, the need for improvement still exists.

### SUMMARY OF THE INVENTION

It is therefore one object of the invention to provide a double-layer containing apparatus having an internal heating mechanism and a process of manufacturing same having the advantages of being convenient in design and having increased heating efficiency due to shorter heat transfer path. Particularly, the invention aims to solve the problems associated with the conventional art as follows. If ultrasonic vibration heating is used, the entire heating device is required to move into the storage space. However, it may be impossible to achieve if the inlet of the container is too small or the storage space is limited. Further, since the conventional container is generally cylindrical, the spacers surround the container in a 360-degree circle. Thus, segmented heating is often required to complete the heating operation of the entire circle (i.e., 360 degrees). However, it is very time-consuming and troublesome. Furthermore, if the inner shell is thicker, the temperature of the electric heating device contacting the inner shell must be increased (or heating time increase) to ensure that the required heating temperature is reached on the first surface. That is, the thicker the inner shell, the greater the temperature difference between the storage space and the first surface, and more likely that properties of the material of the inner shell will deteriorate due to excessively high temperatures. At the same time, the heat transfer path is relatively long.

For achieving above and other objects, the invention provides a double-layer containing apparatus having an internal heating mechanism and a process of manufacturing same in which the double-layer containing apparatus comprises:
a double-layer container including an inner shell, an outer shell, and spacers wherein the inner shell defines a storage space of the double-layer container, the inner shell is made of fluorine-containing thermoplastic and has a first melting point, the spacers are disposed between the inner shell and the outer shell, each of the spacers include a first surface and a second surface, the first surface has recesses facing the inner shell, and the second surface contacts the outer shell; and
a heating device including a controller, wires, and electric heating elements wherein the controller is electrically connected to the electric heating elements through the wires, and the electric heating elements disposed adjacent to the spacers respectively and are disposed in the inner shell wherein the controller activates the electric heating elements to generate heat, corresponding areas of the inner shell adjacent to the recesses are heated to a temperature greater than the first melting point and become melted and deformable into the recesses, projections are formed, and the projections fill the recesses respectively; and then the controller deactivates the electric heating elements to stop generating heat, and the projections cooled and solidified so as to secure to the recesses.

The process of manufacturing a double-layer containing apparatus having an internal heating mechanism comprises the steps of preparing, heating, cooling and solidifying, and finishing.

The above and other objects, features and advantages of the invention will become apparent from the following detailed description taken with the accompanying drawings.

### BRIEF DESCRIPTION OF DRAWINGS

FIG. 1 is a side elevation in part section of a double-layer containing apparatus according to the invention;

FIG. 2 is a broken-away perspective view showing internal details of the double-layer container;

FIG. 3 is a sectional view taken along line III-III of FIG. 2;

FIG. 4 is a greatly enlarged view of a portion of FIG. 2;

FIG. 5 schematically depicts the annular electric heating element of the heating device of the double-layer containing apparatus;

FIG. 6A is a greatly enlarged longitudinal sectional view of the inner shell in FIG. 1 prior to heating;

FIG. 6B is another greatly enlarged longitudinal sectional view of the inner shell in FIG. 6A;

FIG. 7A is a greatly enlarged longitudinal sectional view of the inner shell in FIG. 1 after heating, showing a plastic deformation thereof;

FIG. 7B is another greatly enlarged longitudinal sectional view of the inner shell in FIG. 7A;

FIG. 8 is a flow chart of a process of manufacturing a double-layer containing apparatus having an internal heating mechanism according to the invention;

FIG. 9 is a side elevation in part section of a conventional double-layer containing apparatus;

FIG. 10 is a greatly enlarged longitudinal sectional view of the inner shell in FIG. 9 prior to heating, showing no plastic deformation thereof;

FIG. 11 is a greatly enlarged longitudinal sectional view of the inner shell in FIG. 9 being heated, showing a small plastic deformation thereof; and

FIG. 12 is a greatly enlarged longitudinal sectional view of the inner shell in FIG. 9 after heating, showing a large plastic deformation thereof.

### DETAILED DESCRIPTION OF THE INVENTION

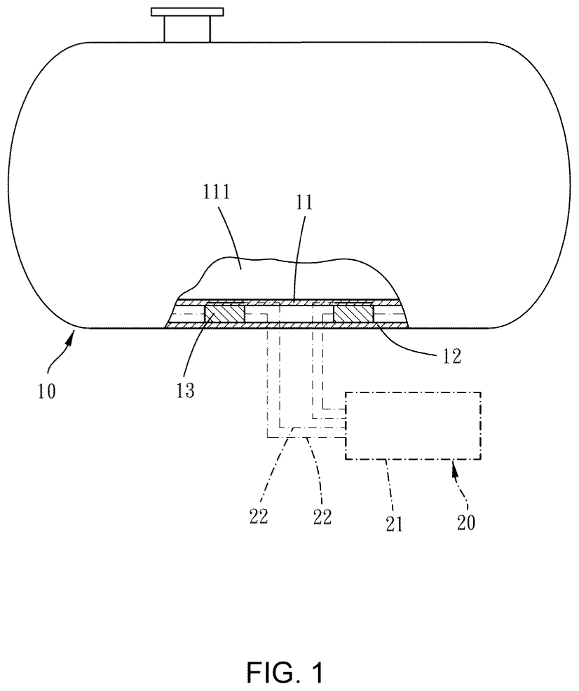

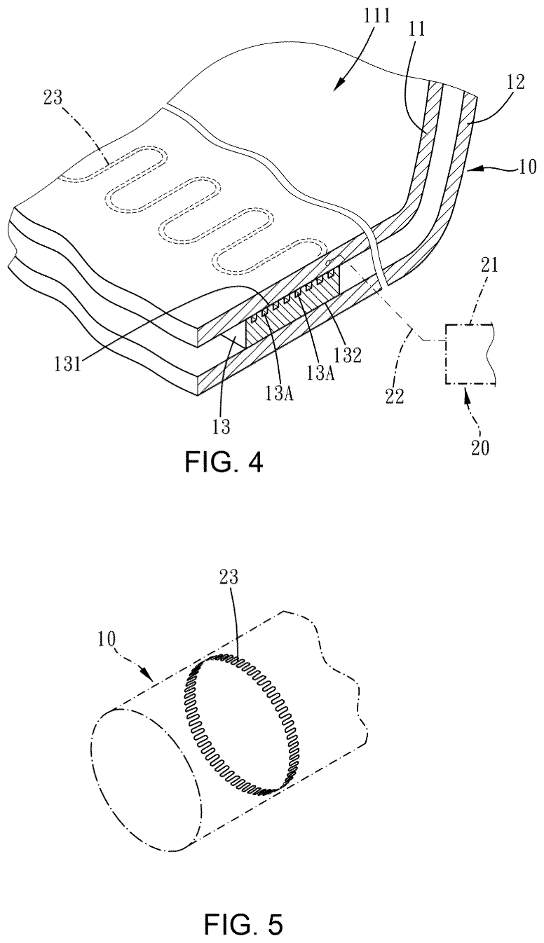

Referring to FIGS. 1 to 7B, a double-layer containing apparatus having an internal heating mechanism and a process of manufacturing same in accordance with the invention is shown and illustrated in which the double-layer containing apparatus comprises the following components as discussed in detail below.

A double-layer container 10 includes an inner shell 11, an outer shell 12, and spacers 13 (or called partitions). The inner shell 11 defines a storage space 111 of the double-layer container 10. The inner shell 11 is made of fluorine-containing thermoplastic and has a first melting point. The spacers 13 are disposed between the inner shell 11 and the outer shell 12. Each of the spacers 13 include a first surface 131 and a second surface 132. The first surface 131 has recesses 13A facing the inner shell 11 and the second surface 132 contacts the outer shell 12 (see FIG. 3).

A heating device 20 includes a controller 21, wires 22, and electric heating elements 23. The controller 21 is electrically connected to the electric heating elements 23 through the wires 22. The electric heating elements 23 are disposed adjacent to the spacers 13 respectively and are disposed in the inner shell 11.

The controller 21 activates the electric heating elements 23 to generate heat. Corresponding areas of the inner shell 11 adjacent to the recesses 13A are heated to a temperature greater than the first melting point and thus become melted and deformable into the recesses (i.e., plastic deformation). And in turn, projections 112 are formed and the projections 112 fill the recesses 13A respectively (see FIGS. 7A and 7B). Next, the controller 21 deactivates the electric heating elements 23 to stop generating heat. And in turn, the projections 112 cooled and solidified so as to secure to the recesses 13A.

In practice, the double-layer container 10 is one of an open container, a cylindrical container, a container having a square section, and a container having a polygonal section.

The inner shell 11 corresponds to the outer shell 12 and each of them are implemented as one of an open shell, a cylindrical shell, a shell having a square section, and a shell having a polygonal section.

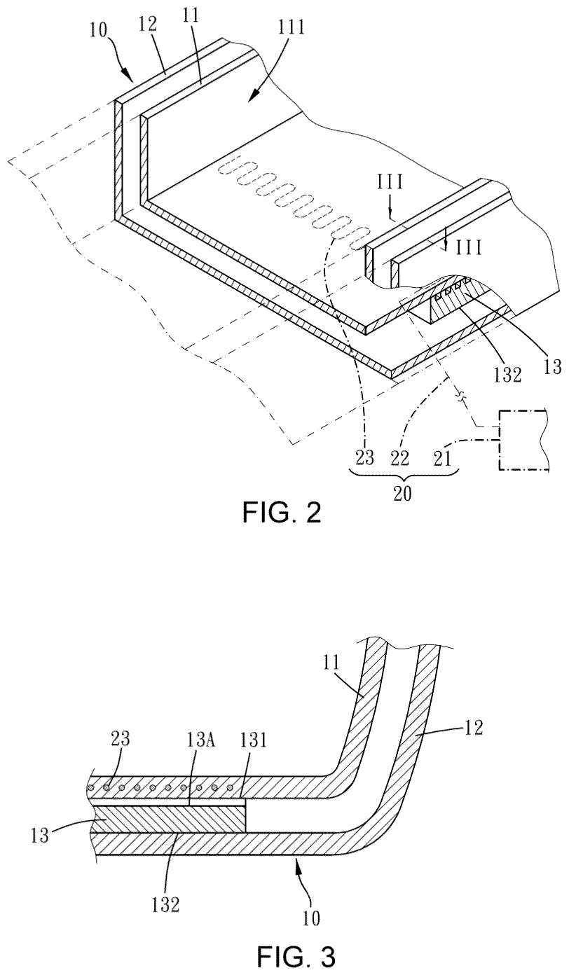

When this invention is applied on an open container condition, each of the electric heating elements 23 are formed as a non-circle segment (not forming as a circle) and is embedded into the inner shell 11 as shown in see FIG. 2. Furthermore, the electric heating element 23 contain connected bends disposed in the inner shell 11. The non-circle segment can be defined as a portion along a cross-sectional structure of the inner shell 11.

When this invention is applied on a close container condition, each of the electric heating elements 23 are disposed and distributed annularly when the electric heating elements 23 are disposed in the cylindrical shell, the shell having a square section, or the shell having a polygonal section (see FIG. 5). Furthermore, the electric heating element 23 contain connected bends disposed in the inner shell 11.

The fluorine-containing thermoplastic is selected from the group consisting of perfluoroalkoxy alkanes (PFA), fluorinated ethylene propylene (FEP), polyvinylidene fluoride (PVDF), polytetrafluoroethylene (PTFE), ethylene chlorotrifluoroethylene (ETCFE) copolymer, and ethylene-tetrafluoroethylene copolymer (ETFE).

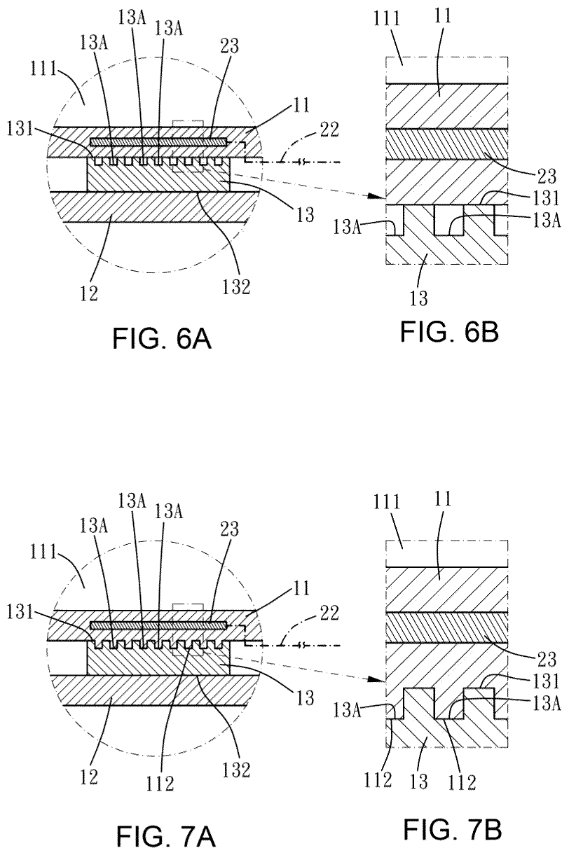

The recesses 13A have a blind end (see FIG. 6A). Alternatively, the recesses 13A can be through holes (not shown).

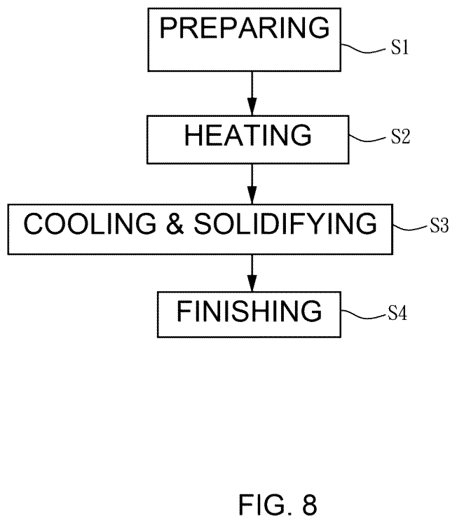

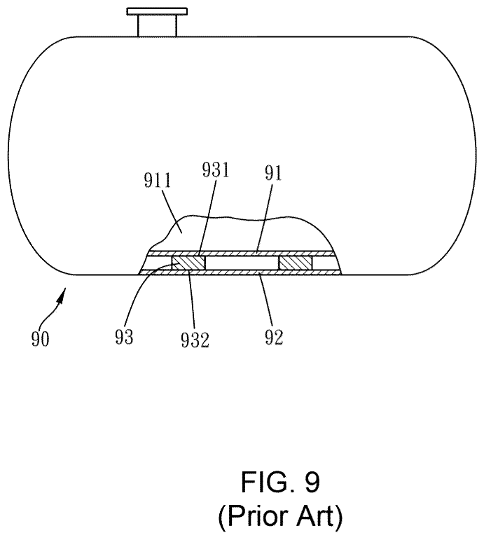

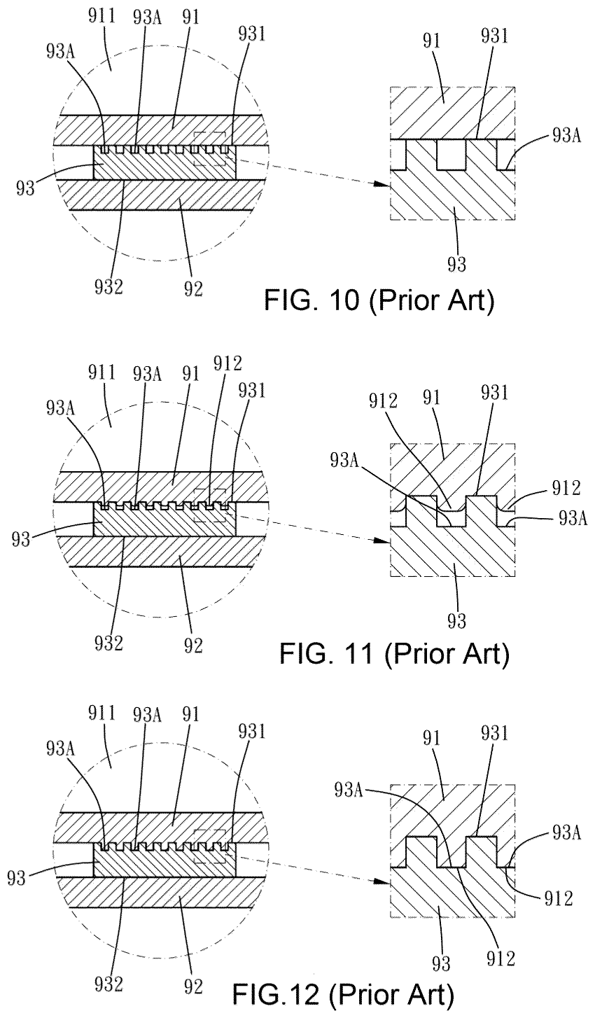

Referring to FIG. 8, a flow chart of a process of manufacturing a double-layer containing apparatus having an internal heating mechanism according to the invention is illustrated. In conjunction with FIGS. 1 to 7B, the process comprises the following steps:
Step S1 of preparing is described below. Firstly, a double-layer container 10 and a heating device 20 are prepared. The double-layer container 10 includes an inner shell 11, an outer shell 12, and spacers 13. The inner shell 11 defines a storage space 111 of the double-layer container 10. The inner shell 11 is made of fluorine-containing thermoplastic and has a first melting point. The spacers 13 are disposed between the inner shell 11 and the outer shell 12. Each of the spacers 13 includes a first surface 131 and a second surface 132. The first surface 131 has a recesses 13A facing the inner shell 11 and the second surface 132 contacts the outer shell 12. The heating device 20 includes a controller 21, wires 22, and electric heating elements 23. The controller 21 is electrically connected to the electric heating elements 23 through the wires 22. The electric heating elements 23 are disposed adjacent to the spacers 13 respectively and are disposed in the inner shell 11.
Step S2 of heating is described below. The controller 21 activates the electric heating elements 23 to generate heat. Corresponding areas of the inner shell 11 adjacent to the recesses 13A are heated to a temperature greater than the first melting point and thus become melted and deformable (i.e., a plastic deformation) into these recesses 13A. And in turn, projections 112 are formed and the projections 112 fill the recesses 13A respectively (see FIGS. 7A and 7B).
Step S3 of cooling and solidifying is described below. The controller 21 deactivates the electric heating elements 23 to stop generating heat. And in turn, the projections 112 are cooled and solidified so as to secure to the recesses 13A.
Step S4 of finishing is described below. The double-layer containing apparatus having an internal heating mechanism is manufactured.

In practice, the double-layer container 10 is one of an open container, a cylindrical container, a container having a square section, and a container having a polygonal section.

The inner shell 11 corresponds to the outer shell 12 (having similar shapes) and each of them are implemented as one of an open shell, a cylindrical shell, a shell having a square section, and a shell having a polygonal section.

When this invention is applied on an open container condition, each of the electric heating elements 23 are formed as a segment (not forming as a circle) and is embedded in the inner shell 11 as shown in see FIG. 2. Furthermore, the electric heating element 23 contains connected bends disposed in the inner shell 11 (when the electric heating elements is disposed in the open shell). The non-circle segment can be defined as a portion along a cross-sectional structure of the inner shell 11.

When this invention is applied on a close container condition, each of the electric heating elements 23 is disposed and distributed annularly when the electric heating elements 23 is disposed in the cylindrical shell, the shell having a square section, or the shell having a polygonal section (see FIG. 5). Furthermore, the electric heating element 23 contain connected bends disposed in the inner shell 11.

It is noted that the annular line formed around the cylindrical shell is an exemplary example. The line may be formed as a closed one around the shell having a square section, or the shell having a polygonal section in other embodiments without departing from the spirit and scope of invention.

The fluorine-containing thermoplastic is selected from the group consisting of perfluoroalkoxy alkanes (PFA), fluorinated ethylene propylene (FEP), polyvinylidene fluoride (PVDF), polytetrafluoroethylene (PTFE), ethylene chlorotrifluoroethylene (ETCFE) copolymer, and ethylene-tetrafluoroethylene copolymer (ETFE).

The recesses 13A have a blind end (see FIG. 6A). Alternatively, the recesses 13A can be through holes (not shown).

The invention has the following advantages and benefits in comparison with the conventional art:

Each of the electric heating elements 23 are embedded in (or disposed in) the inner shell 11. When heating is needed, it is not required to place any heating device inside the storage space 111. In addition, each of the electric heating elements 23 can be formed as a non-circle segment (not a circle) embedded in the inner shell 11 and the electric heating elements 23 faces a specific portion of the inner shell 11 (see FIG. 2; the open container condition). This direct heating is convenient and efficient.

The internal heating mechanism is convenient in design. Each of the electric heating elements 23 are embedded and disposed in the inner shell 11. Any other heating devices are not required to be inserted or placed inside the storage space 111 when heating. The problems of inconvenient insertion and inconvenient movement are solved. Thus, the internal heating mechanism is convenient in design.

Increased heating efficiency due to shorter heat transfer path. Each of the electric heating elements 23 are bent into connected bends disposed in the inner shell 11. The inner shell 11 is heated within the double-layer container 10 rather than being heated from a heating device disposed externally of the double-layer container 10. Thus, the heat transfer path is shorter about one half. And in turn, it increases heating efficiency. Therefore, the invention has an increased heating efficiency due to shorter heat transfer path.

What is claimed is:

1. A double-layer containing apparatus, comprising:
a double-layer container including an inner shell, an outer shell, and spacers wherein the inner shell defines a storage space of the double-layer container, the inner shell is made of fluorine-containing thermoplastic and has a first melting point, the spacers are disposed between the inner shell and the outer shell, each of the spacers include a first surface and a second surface, the first surface has a recesses facing the inner shell, and the second surface contacts the outer shell; and
a heating device including a controller, wires, and electric heating elements wherein the controller is electrically connected to the electric heating elements through the wires, and the electric heating elements are disposed adjacent to the spacers respectively and are disposed in the inner shell;
wherein the controller activates the electric heating elements to generate heat, corresponding areas of the inner shell adjacent to the recesses are heated to a temperature greater than the first melting point and become melted and deformable into the recesses, projections are formed, and the projections fill the recesses respectively; and then he controller deactivates the electric heating elements to stop generating heat, and the projections are cooled and solidified so as to secure to the recesses.

2. The double-layer containing apparatus of claim 1, wherein the double-layer container is one of an open container, a cylindrical container, a container having a square section, and a container having a polygonal section; and the inner shell corresponds to the outer shell and each of the inner shell and the outer shell are one of an open shell, a cylindrical shell, a shell having a square section, and a shell having a polygonal section.

3. The double-layer containing apparatus of claim 2, wherein each of the electric heating elements are formed as a non-circle segment and is embedded in the inner shell; the electric heating element contains connected bends disposed in the inner shell when the electric heating elements are disposed in the open shell; and the non-circle segment is defined as a portion along a cross-sectional structure of the inner shell.

4. The double-layer containing apparatus of claim 2, wherein each of the electric heating elements is disposed and distributed annularly when the electric heating elements are disposed in the cylindrical shell, the shell having a square section, or the shell having a polygonal section.

5. The double-layer containing apparatus of claim 1, wherein the fluorine-containing thermoplastic is selected from the group consisting of perfluoroalkoxy alkanes (PFA), fluorinated ethylene propylene (FEP), polyvinylidene fluoride (PVDF), polytetrafluoroethylene (PTFE), ethylene chlorotrifluoroethylene (ETCFE) copolymer, and ethylene-tetrafluoroethylene copolymer (ETFE).

6. A process of manufacturing a double-layer containing apparatus, comprising the steps of:
preparing a double-layer container and a heating device wherein the double-layer container includes an inner shell, an outer shell, and spacers, the inner shell defines a storage space of the double-layer container, the inner shell is made of fluorine-containing thermoplastic and has a first melting point, the spacers are disposed between the inner shell and the outer shell, each of the spacers include a first surface and a second surface, the first surface has a recesses facing the inner shell and the second surface contacts the outer shell; and the heating device includes a controller, wires, and electric heating elements, the controller is electrically connected to the electric heating elements through the wires, the electric heating elements disposed adjacent to the spacers respectively and are disposed in the inner shell;
causing the controller to activate the electric heating elements to generate heat wherein corresponding areas of the inner shell adjacent to the recesses are heated to a temperature greater than the first melting point and become melted and deformable into the recesses, projections are formed, and the projections fill the recesses respectively;
causing the controller to deactivate the electric heating elements to stop generating heat, and the projections are cooled and solidified so as to secure to the recesses; and
producing a finished double-layer containing apparatus having an internal heating mechanism.

7. The process of claim 6, wherein the double-layer container is one of an open container, a cylindrical container, a container having a square section, and a container having a polygonal section; and the inner shell corresponds to the outer shell and each of the inner shell and the outer shell are one of an open shell, a cylindrical shell, a shell having a square section, and a shell having a polygonal section.

8. The process of claim 7, wherein each of the electric heating elements are formed as a non-circle segment and is embedded in the inner shell; the electric heating element contains connected bends disposed in the inner shell when the electric heating elements are disposed in the open shell, and the non-circle segment is defined as a portion along a cross-sectional structure of the inner shell.

9. The process of claim 7, wherein each of the electric heating elements is disposed and distributed annularly when the electric heating elements are disposed in the cylindrical shell, the shell having a square section, or the shell having a polygonal section.

10. The process of claim 6, wherein the fluorine-containing thermoplastic is selected from the group consisting of perfluoroalkoxy alkanes (PFA), fluorinated ethylene propylene (FEP), polyvinylidene fluoride (PVDF), polytetrafluoroethylene (PTFE), ethylene chlorotrifluoroethylene (ETCFE) copolymer, and ethylene-tetrafluoroethylene copolymer (ETFE).
